(19) United States
(12) Patent Application Publication
(10) Pub. No.: US 2024/0078521 A1
(43) Pub. Date: Mar. 7, 2024

(54) MANAGEMENT APPARATUS, MANAGEMENT METHOD, AND STORAGE MEDIUM

(71) Applicant: HONDA MOTOR CO., LTD., Tokyo (JP)

(72) Inventors: Akito Tanihata, Tokyo (JP); Hiromasa Takahashi, Tokyo (JP)

(21) Appl. No.: 18/236,427

(22) Filed: Aug. 22, 2023

(30) Foreign Application Priority Data
Sep. 6, 2022 (JP) 2022-141224

(51) Int. Cl. G06Q 10/30; G06Q 50/04

(52) U.S. Cl. CPC G06Q 10/30; G06Q 50/04

(57) ABSTRACT

A management apparatus according to an embodiment includes an acquirer configured to acquire a degree of deterioration of each part included in a vehicle, a selector configured to select a part having a degree of deterioration acquired by the acquirer, less than a threshold value, from among parts included in the vehicle, and an identifier configured to identify a diversion destination vehicle to which the selected part will be diverted.

### CROSS-REFERENCE TO RELATED APPLICATION

Priority is claimed on Japanese Patent Application No. 2022-141224, filed Sep. 6, 2022, the content of which is incorporated herein by reference.

### BACKGROUND

### Field of the Invention

The present invention relates to a management apparatus, a management method, and a storage medium.

### Description of Related Art

Conventionally, efforts aimed at mitigating climate change or reducing the influence of climate change have been ongoing, and research and development on reducing carbon dioxide emissions is being carried out to achieve this. Since carbon dioxide is emitted when products such as vehicles are collected and when new parts are manufactured, it is desired to reduce emissions by using existing parts for a long period of time and making effective use of them through reuse. In this regard, there is known a technique of acquiring states of vehicle parts from a sensor, determining deterioration states, and notifying times regarding the parts (for example, Japanese Patent Application Laid-Open Nos. 2002-370630 and 2021-156347).

### SUMMARY

Incidentally, in reducing carbon dioxide emissions, conventional techniques have a problem that they do not take into account effective reuse of vehicle parts to reduce carbon dioxide emissions.

In order to solve the above problem, an object of the present application is to reduce carbon dioxide emissions by reusing vehicle parts more effectively. Consequently, the present application contributes to mitigation of climate change or reduction of the influence thereof.

A management apparatus, a management method, and a storage medium according to the present invention employ the following configurations.

(1): A management apparatus according to one aspect of the present invention is a management apparatus including: an acquirer configured to acquire a degree of deterioration of each of parts included in a vehicle; a selector configured to select a part having a degree of deterioration acquired by the acquirer, which is less than a threshold value, from among parts included in the vehicle; and an identifier configured to identify a diversion destination vehicle to which the selected part will be diverted.

(2): In the aforementioned aspect of (1), the selector changes the threshold value on the basis of attribute information of a user who uses the diversion destination vehicle.

(3): In the aforementioned aspect of (1), the identifier identifies the diversion destination vehicle on the basis of the attribute information of the user who uses the diversion destination vehicle or attribute information of the diversion destination vehicle.

(4): In the aforementioned aspect of (1), the identifier determines whether a reuse vehicle is able to be manufactured using the part selected by the selector.

(5): In the aforementioned aspect of (1), the acquirer further acquires an energy consumption during manufacture at the time of newly manufacturing the part, and in a case where there are a plurality of parts of the same type, the selector preferentially selects a part with a higher energy consumption during manufacture from among the parts.

(6): In the aforementioned aspect of (1), the acquirer further acquires an energy consumption during diversion at the time of diverting the parts to another vehicle, and in a case where there are a plurality of parts of the same type, the selector preferentially selects a part with a lower energy consumption during diversion from among the parts.

(7): In the aforementioned aspect of (1), the acquirer acquires an energy consumption during manufacture at the time of newly manufacturing the part and an energy consumption during diversion at the time of diverting the part to another vehicle, and the selector selects the part on the basis of the degree of deterioration and a result of comparison between the energy consumption during manufacture and the energy consumption during diversion.

(8): In the aforementioned aspect of (7), the energy consumption during diversion includes energy consumption at the time of collecting parts from the vehicle.

(9): A management method according to another aspect of the present invention is a management method, using a computer, including: acquiring a degree of deterioration of each part included in a vehicle; selecting a part having a degree of deterioration acquired by the acquirer, less than a threshold value, from among parts included in the vehicle; and identifying a diversion destination vehicle to which the selected part will be diverted.

(10): A storage medium according to another aspect of the present invention is a computer-readable non-transitory storage medium storing a program causing a computer to: acquire a degree of deterioration of each part included in a vehicle; select a part having a degree of deterioration acquired by the acquirer, less than a threshold value, from among parts included in the vehicle; and identify a diversion destination vehicle to which the selected part will be diverted.

According to the aspects (1) to (10) above, it is possible to reduce carbon dioxide emissions using parts included in a vehicle more efficiently.

### BRIEF DESCRIPTION OF THE DRAWINGS

FIG. 1 is a diagram showing an example of a configuration of a management system including a management apparatus according to an embodiment.

FIG. 2 is a diagram showing an example of a schematic configuration of a vehicle M.

FIG. 3 is a diagram showing an example of the content of a user information DB.

FIG. 4 is a diagram showing an example of the content of a vehicle information DB.

FIG. 5 is a diagram showing an example of the content of an energy consumption DB.

FIG. 6 is a diagram illustrating processing executed by a management server.

FIG. 7 is a diagram illustrating first processing executed by the management server.

FIG. 8 is a diagram illustrating second processing executed by the management server.

FIG. 9 is a diagram illustrating third processing executed by the management server.

FIG. 10 is a flowchart showing an example of processing executed by the management server of an embodiment.

### DESCRIPTION OF EMBODIMENTS

Hereinafter, embodiments of a management apparatus, a management method, and a storage medium of the present invention will be described with reference to the drawings. In the following description, it is assumed that a management target in the management apparatus of an embodiment is a part of a vehicle. Vehicles include, for example, two-wheeled, three-wheeled, or four-wheeled vehicles, micro-mobility, and the like, and a driving source thereof is an internal combustion engine such as a diesel engine or a gasoline engine, an electric motor, or a combination thereof. The electric motor operates using power generated by a generator coupled to the internal combustion engine or using power discharged from a battery (an example of a storage battery). Vehicles that are management targets may include, for example, all moving bodies that can be moved by people (occupants) on board. The parts include exterior parts (vehicle body parts), in-vehicle parts, interior parts (vehicle interior parts), and other vehicle equipment.

### [System Configuration]

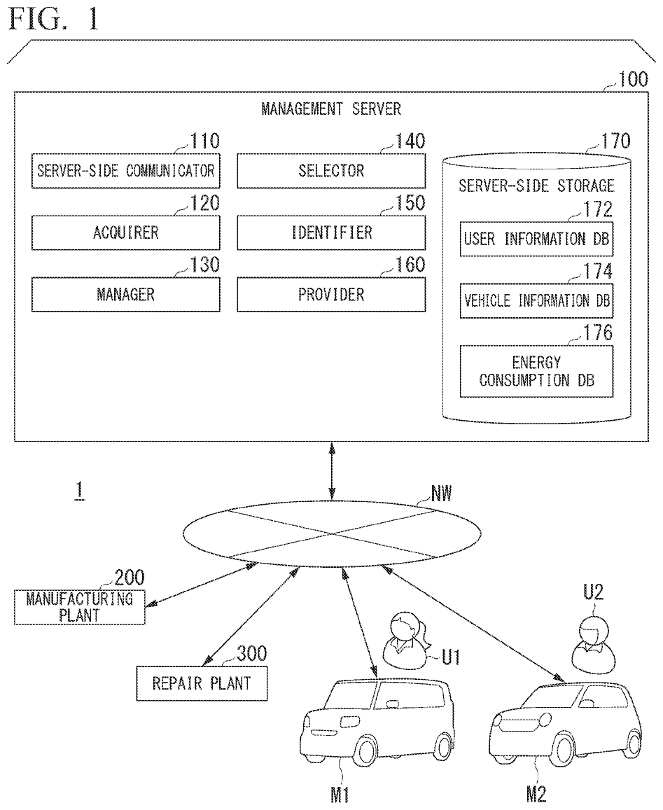

FIG. 1 is a diagram showing an example of a configuration of a management system 1 including a management apparatus according to an embodiment. The management system 1 shown in FIG. 1 includes a management server 100 and one or more vehicles M, for example. In FIG. 1, as an example, a vehicle M1 used by a user U1 and a vehicle M2 used by a user U2 are shown. Hereinafter, the vehicles M1 and M2 are collectively simply referred to as a “vehicle M” except when the vehicles M1 and M2 are identified and described. Similarly, the users will be collectively simply referred to as a “user U.” As shown in FIG. 1, the management system 1 may include a manufacturing plant 200 in which the main body of the vehicle M, parts of the vehicle M, and the like are manufactured, and a repair plant 300 in which repair (including replacement) of the vehicle M, parts of the vehicle M, and the like is performed. The management server 100, the vehicle M, the manufacturing plant 200, and the repair plant 300 are connected via a network NW, for example, such that they can communicate. The network NW includes, for example, the Internet, a cellular network, a Wi-Fi network, a wide area network (WAN), a local area network (LAN), a provider device, a wireless base station, and the like. The management system 1 may include one or more manufacturing plants 200 and one or more repair plants 300. For example, each of the manufacturing plant 200 and the repair plant 300 is provided with a terminal device, and communicates with the management server 100 via the network NW. The manufacturing plant 200 and the repair plant 300 may be, for example, one facility or a vehicle store such as a dealer. The repair plant 300 may be a facility for performing processing such as reuse on scrapped vehicles. The management server 100 may be included in the manufacturing plant 200 or the repair plant 300. The management server 100 is an example of a “management apparatus.”

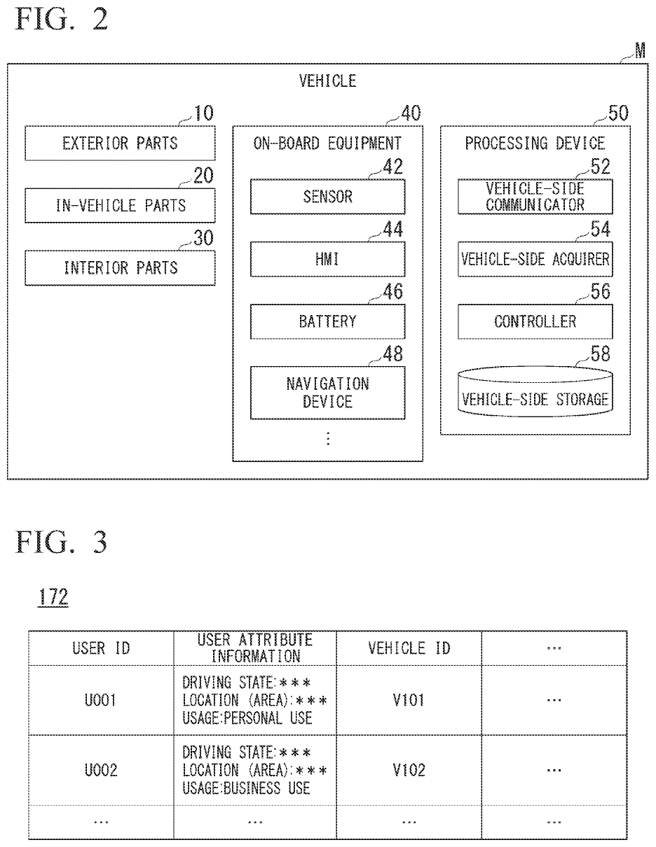

FIG. 2 is a diagram showing an example of a schematic configuration of the vehicle M. The vehicle M includes, for example, exterior parts 10, in-vehicle parts 20, interior parts 30, on-board equipment 40, and a processing device 50. The exterior parts include, for example, a hood, a roof, a pillar, a bumper, windows (glass), doors, wipers, a trunk lid, tires, and the like. The in-vehicle parts 20 include, for example, an engine, an ignition device, a radiator, a transmission, a drive shaft, a suspension, a muffler (exhaust system device), a driving assistance device that automatically controls at least one of steering or speed of the vehicle M, and the like. The interior parts 30 include, for example, an instrument panel (dashboard), a shift lever, a center console, driving operators (steering wheel, accelerator pedal, and brake pedal), seats, and the like.

The on-board equipment 40 includes, for example, a sensor 42, a human machine interface (HMI) 44, a battery 46, and a navigation device 48. The sensor 42 includes an external sensor that recognizes the surrounding situation (surrounding objects and the like) of the vehicle M using a camera, a radar device, and the like, a vehicle speed sensor that detects the speed of the vehicle M, an acceleration sensor that detects an acceleration, and a yaw rate sensor that detects an angular velocity around a vertical axis. The sensor 42 may include an operation sensor that detects the amount of operation of the vehicle M by the user U (for example, the amount of steering or the amount of acceleration/deceleration of the vehicle M during manual operation using a driving operator). The sensor 42 may include a position sensor that acquires the position of vehicle M. The sensor 42 may include a battery sensor that detects the amount of charge accumulated in the battery 46 and a degree of deterioration.

The HMI 44 presents various types of information to the user U of the vehicle M and receives input operations of the user U. The HMI 44 includes, for example, a display device, a speaker, a microphone, a buzzer, a touch panel, keys, and the like. The battery 46 is, for example, a secondary battery such as a lithium ion battery or an all-solid battery and stores electric power for driving the vehicle M. For example, the battery 46 stores electric power supplied from an external charging facility, charges the electric power, and discharges the electric power such that the vehicle M can travel. The battery 46 may store electric power by regenerative energy. The navigation device 48 acquires surrounding information based on the position of the vehicle M from pre-stored map information and causes the HMI 44 to display the acquired surrounding information, or displays a route to a destination set by the user U, for example. The map information is stored in the navigation device 48 or a vehicle-side storage 58, for example. Furthermore, the on-board equipment 40 may include a drive recorder, lighting equipment, audio equipment, and the like.

The processing device 50 includes, for example, a vehicle-side communicator 52, a vehicle-side acquirer 54, a controller 56, and the vehicle-side storage 58. The vehicle-side acquirer 54 and the controller 56 are each realized by a hardware processor such as a central processing unit (CPU) executing a program (software). Some or all of these components may be realized by hardware (circuit part including circuitry) such as a large scale integration (LSI) circuit, an application specific integrated circuit (ASIC), a field-programmable gate array (FPGA), and a graphics processing unit (GPU) or realized by software and hardware in cooperation. The program may be stored in advance in a storage device (a storage device including a non-transitory storage medium) such as a hard disk drive (HDD) or a flash memory included in the processing device 50, or may be stored in a removable storage medium (non-transitory storage medium) such as a DVD or a CD-ROM and installed in an HDD or a flash memory when the storage medium is set in a drive device included in the processing device 50.

The vehicle-side storage 58 may be realized by the above-described various storage devices, a solid state drive (SSD), an electrically erasable programmable read only memory (EEPROM), a read only memory (ROM), a random access memory (RAM), or the like. For example, information obtained from the on-board equipment 40, programs, and other various types of information are stored in the vehicle-side storage 58. Information on the user U may be stored in the vehicle-side storage 58.

The vehicle-side communicator 52 communicates with the management server 100 via the network NW. The vehicle-side communicator 52 may communicate with other vehicles M, the manufacturing plant 200, the repair plant 300, and other external devices.

The vehicle-side acquirer 54 acquires various types of information obtained from the on-board equipment 40 and acquires information transmitted from the management server 100 or the like via the vehicle-side communicator 52.

The controller 56 controls all the components provided in the vehicle M. For example, the controller 56 transmits information obtained from the on-board equipment and information (for example, a driving history and the like) on the user U who uses the vehicle M to the management server 100. The controller 56 receives instructions from the user U and the management server 100, controls the start and stop of each component in the vehicle, controls driving of each part, and transmits information acquired by the vehicle-side acquirer 54 to the management server 100 via the vehicle-side communicator 52.

Each component included in the exterior parts 10, the in-vehicle parts 20, the interior parts 30, the on-board equipment 40, and the processing device 50 shown in FIG. 2 is an example of a “part” in the embodiment. Parts are not limited to the content described above, and one part may be further subdivided into a plurality of parts or a plurality of parts may be integrally configured as a unit. Parts may include parts that can be used not only for the same vehicle model but also for a plurality of different vehicle models.

Referring back to FIG. 1, the management server 100 acquires information on the vehicle M, information on the user U, information obtained from the manufacturing plant 200 and the repair plant 300 and manages the vehicle M and parts of the vehicle. The management server 100 may be realized, for example, in a server device or a storage device incorporated in a cloud computing system. In this case, the functions of the management server 100 may be realized by a plurality of server devices and storage devices in the cloud computing system.

The management server 100 shown in FIG. 1 includes, for example, a server-side communicator 110, an acquirer 120, a manager 130, a selector 140, an identifier 150, a provider 160, and a server-side storage 170. The acquirer 120, the manager 130, the selector 140, the identifier 150, and the provider 160 are each realized by a hardware processor such as a CPU executing a program (software). Some or all of these components may be realized by hardware (circuit part including circuitry) such as an LSI circuit, an ASIC, an FPGA, a GPU, and the like, or realized by software and hardware in cooperation. The program may be stored in advance in a storage device (storage device including a non-transitory storage medium) such as an HDD or a flash memory provided in the management server 100, or may be stored in a removable storage medium (non-transitory storage medium) such as a DVD or CD-ROM and installed in an HDD or a flash memory included in the management server 100 when the storage medium is set in a drive device included in the management server 100.

The server-side storage 170 may be realized by the various storage devices described above, an SSD, an EEPROM, a ROM, a RAM, or the like. The server-side storage 170 stores, for example, a user information DB (database) 172, a vehicle information DB 174, an energy consumption DB 176, programs, and other various types of information.

FIG. 3 is a diagram showing an example of the content of the user information DB 172. In the user information DB 172, for example, a user ID as identification information for identifying the user U of the vehicle M is associated with user attribute information and a vehicle ID as identification information for identifying the vehicle M. The user information DB 172 may store other types of identification information (personal information and the like) such as a user name, address, and telephone number instead of (or in addition to) the user ID and may store information (region, vehicle type, usage, and vehicle number) indicated on a license plate (automobile registration number mark) instead of (or in addition to) the vehicle ID. The user attribute information includes, for example, information such as a driving state of the user U, the location (region) of the user corresponding to the address, and usage. The driving state includes, for example, index values regarding driving of the user U, such as degrees of acceleration and deceleration when the user U is driving, frequencies of sudden acceleration, sudden deceleration, and sharp steering, the frequency of boarding in a predetermined period, and the average travel distance and average travel time per ride. The driving state may include the number of years elapsed since the user U obtained a driver's license and an index value indicating the skill of driving. The location (area) may be the address of the user U (in other words, the location where the vehicle is parked in a garage or parking lot), or area information indicating that a parking location is a salt-damaged area (for example, near a coast) or a heavy snowfall area. The usage includes, for example, information indicating whether the vehicle is for personal (family) use or for business use (for example, use as a vehicle operated under company management such as lease use, rental car use, and commercial vehicle use). Information registered in the user information DB 172 may be input by the user at the time of user registration for services provided by the management system 1 and may be obtained from information acquired from the vehicle M driven by the user U through the manager 130 or the controller 56 of the vehicle M, for example.

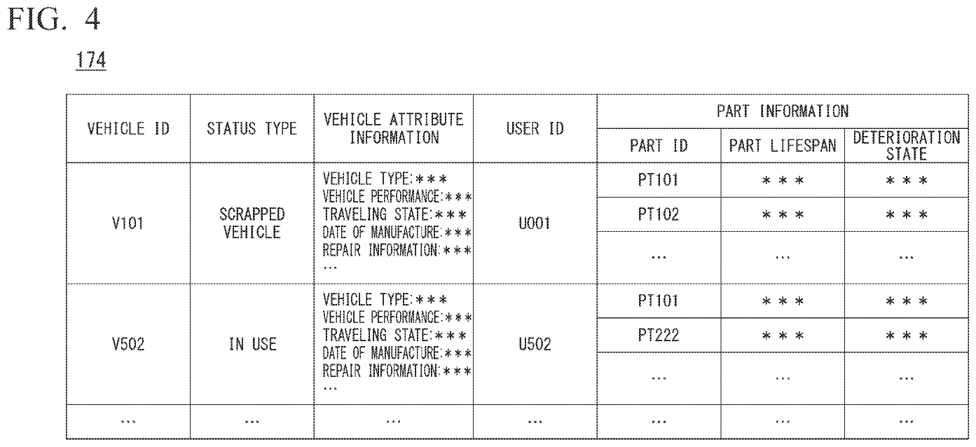

FIG. 4 is a diagram showing an example of the content of the vehicle information DB 174. In the vehicle information DB 174, for example, a vehicle ID is associated with a status type, vehicle attribute information, a user ID, and part information. Information such as whether the vehicle M is being used by the user U or whether the vehicle is scrapped is stored in the status type as a current usage status of the vehicle M. That is, the vehicle information DB 174 can contain information on vehicles in use and vehicles that have been scrapped. The vehicle attribute information includes, for example, a vehicle type, vehicle performance, a traveling state, repair information, and the like. The vehicle type includes, for example, information such as the date of manufacture in addition to the type of vehicle. The vehicle performance includes, for example, information on the performance of driving parts such as an engine and on-vehicle equipment such as a battery. The traveling state includes index values regarding traveling of the vehicle M, such as the number of travels, traveling distance, traveling time, degrees of acceleration and deceleration, frequencies of sudden acceleration, sudden deceleration, and sharp steering in a predetermined period. The repair information includes repaired (including replaced) parts, a repair date, and the like. The user ID stores identification information of a user who is currently using or a user who was using in the past (for example, immediately before). The part information is associated with a part ID as identification information for identifying each part mounted on the vehicle M, a predetermined lifespan of each part, and a deterioration state of each part. The lifespan of a part may be the remaining lifespan of the part set or updated by the manager 130, for example. The deterioration state includes, for example, an index value (degree of deterioration) indicating the degree of deterioration. The vehicle information DB 174 may store a deterioration state of the entire vehicle in addition to each part ID. Information registered in the vehicle information DB 174 may be acquired from the manufacturing plant 200 or the repair plant 300, or may be generated by the manager 130 from information obtained from the vehicle M, for example.

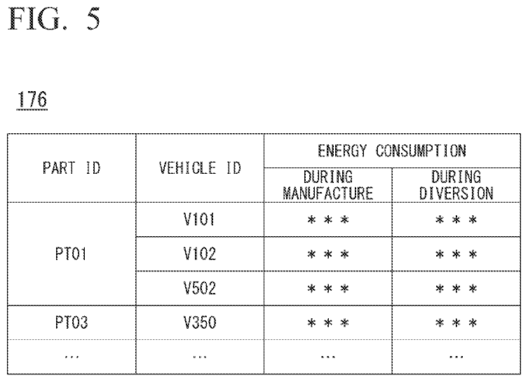

FIG. 5 is a diagram showing an example of the content of the energy consumption DB 176. In the energy consumption DB 176, for example, an energy consumption is associated with a part ID. An energy consumption is, for example, greenhouse gas emissions. Greenhouse gases include, for example, carbon dioxide, but also include methane gas, dinitrogen monoxide, chlorofluorocarbons, and the like. The energy consumption stored in the energy consumption DB 176 includes an energy consumption when new vehicle parts are manufactured (energy consumption during manufacture) and an energy consumption when parts are diverted to another vehicle (energy consumption during diversion). The energy consumption during manufacture is, for example, carbon dioxide emissions in manufacturing parts. Here, the carbon dioxide emissions in manufacturing parts may include all carbon dioxide emissions in processes all the way back to mining of raw materials used for the parts. The energy consumption during diversion is, for example, carbon dioxide emissions when parts are diverted to another vehicle. The energy consumption during diversion may include an energy consumption and the like caused by recovery work such as removal of parts from a vehicle body and transport of parts, simple repair work for reuse, maintenance work, and the like. Information registered in the energy consumption DB 176 may be obtained from, for example, the manufacturing plant 200 or the repair plant 300, or may be obtained from a terminal device of an organization or institution that manages an energy consumption via the network NW.

Referring back to FIG. 1, the server-side communicator 110 communicates with vehicle M, the manufacturing plant 200, the repair plant 300, and other external devices via the network NW.

The acquirer 120 acquires information transmitted from the vehicle M, the manufacturing plant 200, the repair plant 300, and other external devices. For example, information registered in the user information DB 172 and the vehicle information DB 174 is acquired from the vehicle M. The acquirer 120 may acquire a degree of deterioration of each part included in the vehicle M on the basis of information acquired from the vehicle M, for example. The acquirer 120 may acquire information registered in the energy consumption DB 176 from the manufacturing plant 200, the repair plant 300, and other external devices, for example.

The manager 130 manages users U who use the services provided by the management system 1 and the parts of the vehicle M on the basis of information acquired by the acquirer 120. For example, the manager 130 manages state deterioration of each part of the vehicle M on the basis of the user attribute information and the vehicle attribute information. The manager 130 may manage manufacturing of reuse vehicles using parts whose degrees of deterioration are less than a threshold value on the basis of the degree of deterioration of each part included in one or more scrapped vehicles.

The selector 140 selects, from among the parts included in the vehicle M, a part whose degree of deterioration acquired by the acquirer 120 is less than a threshold value. For example, the selector 140 may change the threshold value on the basis of attribute information (user attribute information) of a user who uses a diversion destination vehicle. The selector 140 may select a part on the basis of the degree of deterioration and the energy consumption of the part. In a case where there are a plurality of parts of the same type, the selector 140 may set priorities on the basis of the energy consumption of each part and preferentially select a part with a higher priority.

The identifier 150 identifies a diversion destination vehicle to which a part set by the selector 140 is to be diverted. For example, the identifier 150 identifies the diversion destination vehicle on the basis of one or both of user attribute information and vehicle attribute information of the diversion destination vehicle. The identifier 150 may identify a part whose degree of deterioration exceeds an upper limit as a part to be discarded (a part that is not to be reused).

The provider 160 provides various types of information to users of the management system 1 and the like. Providing various types of information means, for example, generating and outputting one or both of an image and/or sound indicating information to be provided. For example, the provider 160 provides information on a selected part to a diversion destination vehicle identified by the identifier 150, or provides information on a selected part or an identified diversion destination vehicle to the manufacturing plant 200 and the repair plant 300. The provider 160 may generate responses to inquiries and requests from the outside (for example, the manufacturing plant 200, the repair plant 300, and the user U) and provide the generated response information. The provider 160 may provide information to a terminal device (for example, a smart phone or a tablet terminal) used by the user U of the vehicle M, other external devices on the network NW, and the like.

### [Management of Vehicle Parts]

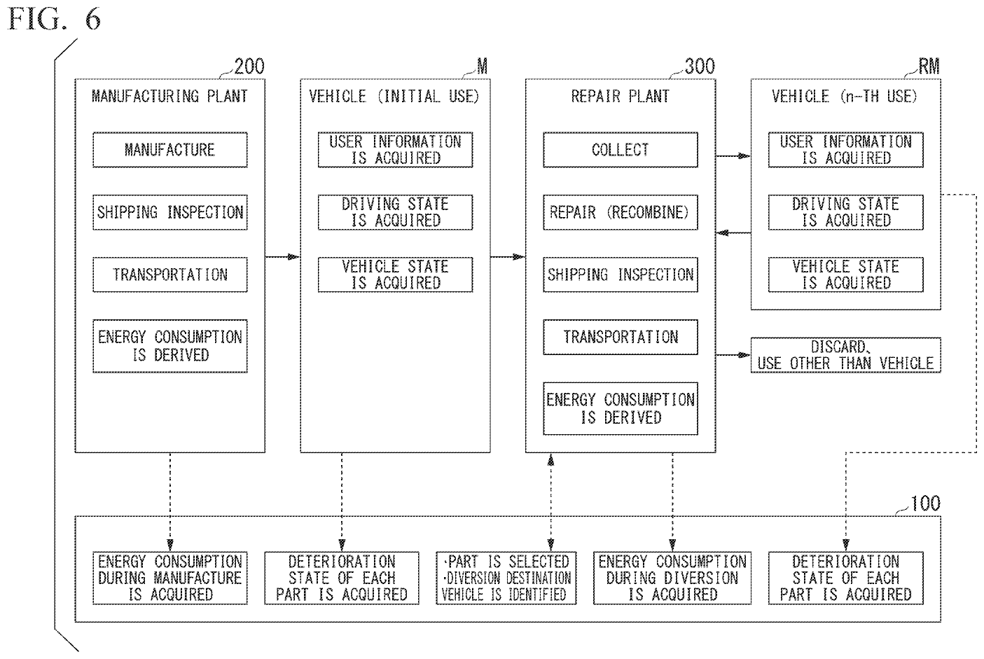

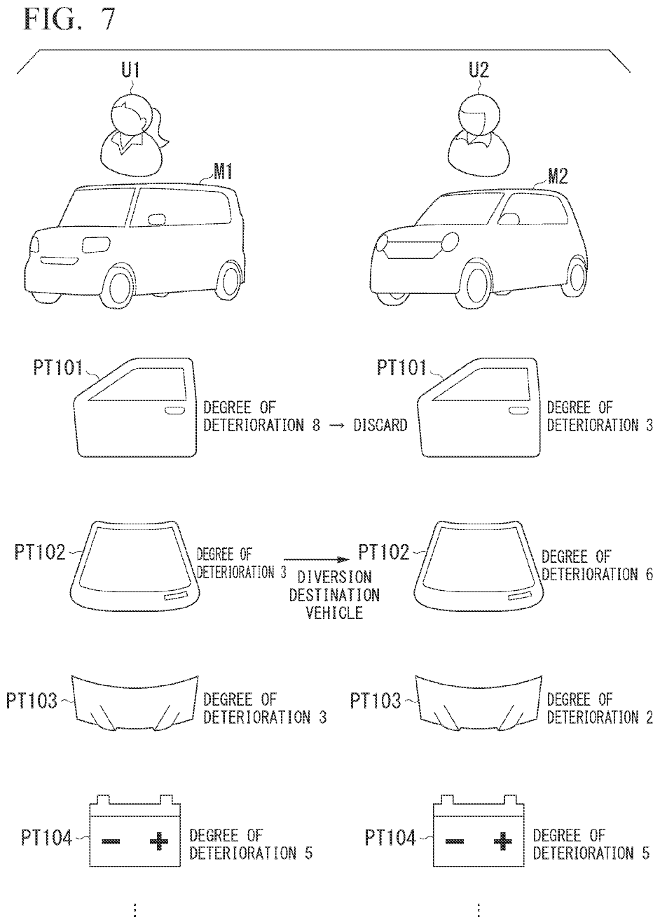

Next, processing executed by the management server 100 (vehicle part management processing) will be specifically described. FIG. 6 is a diagram illustrating management processing executed by the management server 100. The example of FIG. 6 schematically shows a flow of new manufacturing of the vehicle M, disposal, and subsequent reuse, managed by the management server 100. First, in a vehicle manufacturing process at the manufacturing plant 200, manufacturing of new parts and manufacturing of a new vehicle using the manufactured parts are performed, shipping inspection and the like are performed after manufacture, and then the vehicle M is transported to a store or the like to be provided to the user U. The manufacturing plant 200 derives the energy consumption during manufacture of the vehicle M, associates the derived energy consumption during manufacture with the manufactured vehicle and parts, and transmits the energy consumption associated with the vehicle and parts to the management server 100. The manager 130 of the management server 100 acquires information such as the energy consumption during manufacture transmitted from the manufacturing plant 200, stores the information in the energy consumption DB 176 in association with part IDs and the vehicle ID, and manages the information. The energy consumption during manufacture is not obtained directly from the manufacturing plant 200, and a specified value for the energy consumption during manufacture may be obtained by inquiring a terminal device of an organization or institution that manages the energy consumption using the vehicle ID, part IDs, or the like. The same applies to energy consumption during diversion.

When the vehicle M is used for the first time, for example, the vehicle M acquires user information input by the user U, and a traveling state, a vehicle state, and the like through the sensor 42, and transmits the acquired information to the management server 100 at a predetermined cycle or a predetermined timing. The manager 130 of the management server 100 stores (updates) information in the user information DB 172 on the basis of the user information and traveling state information acquired by the acquirer 120, and stores (updates) information in the vehicle information DB 174 on the basis of the traveling state information and vehicle state condition acquired by the acquirer 120.

Next, in a case where the vehicle M breaks down and needs to be repaired or a case where the vehicle M is scrapped to replace it with another vehicle, the vehicle M is transported to the repair plant 300. At the repair plant 300, parts of the vehicle M are collected, repair is made by recombining parts and the like, a reuse vehicle is manufactured, subsequent shipping inspection is performed, and the vehicle M is transported to a user. Here, the management server 100 performs selection of a part with a low degree of deterioration on the basis of information stored in the server-side storage 170, identification of a diversion destination vehicle on the basis of deterioration states of parts, and the like. In a case where there is an inquiry about used parts for a part that needs to be replaced, search for applicable used parts may be performed. Information managed by the management server 100 is transmitted to the repair plant 300, and ordering of parts, repairing, manufacturing of a reuse vehicle, and the like are performed at the repair plant 300 or the like. A specific example of processing of the management server 100 here will be described later.

The repair plant 300 derives an energy consumption during diversion caused by the above-described process, associates the derived energy consumption during diversion with a repaired target (vehicle or part), and transmits it to the management server 100. The manager 130 of the management server 100 acquires information such as the energy consumption during diversion transmitted from the repair plant 300, stores the information in the energy consumption DB 176 in association with a part ID and a vehicle ID, and manages the information.

A vehicle repaired at the repair plant 300 (hereinafter referred to as a “reuse vehicle RM”) is secondarily used by the same or another user. In this case, the reuse vehicle RM newly acquires user information, a traveling state, and a vehicle state, and transmits the acquired information to the management server 100. The management server 100 registers information in the user information DB 172 and the vehicle information DB 174 on the basis of the acquired information. When the reuse vehicle RM breaks down or changes to another vehicle, it is repaired again at the repair plant 300, and by repeating this process, n-th use can be realized. Parts that cannot be reused due to degrees of deterioration are discarded or used as parts for products other than vehicles, thereby recycling resources.

### [Selection of Part and Identification of Diversion Destination Vehicle]

Next, selection of a part included in the vehicle M and identification of a diversion destination vehicle in the management server 100 will be described. In the following, processing executed by the management server 100 will be divided into several parts and described.

<First Processing>

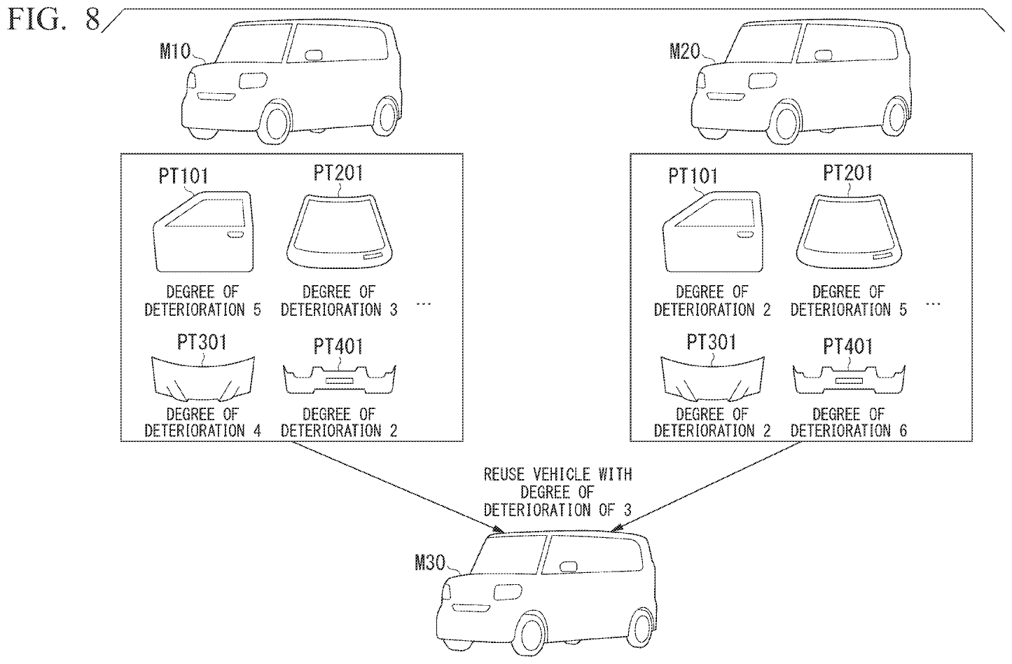

FIG. 7 is a diagram illustrating first processing executed by the management server 100. In the first processing, a vehicle M1 in which a user U1 was riding is scrapped and the parts included in the vehicle M1 are reused. In the example of FIG. 7, it is assumed that user attribute information of users U1 and U2, vehicle attribute information of vehicles M1 and M2, and the like are managed by manager 130. In the example of FIG. 7, it is assumed that parts PT101 to PT104 are common parts that can be used for each of the vehicles M1 and M2. As for the degree of deterioration of each part shown in FIG. 7, the larger the numerical value, the more deteriorated (the greater the damage).

The manager 130 manages the types of parts included in each of the vehicles M1 and M2 and the degree of deterioration of each part. For example, the manager 130 derives the degree of deterioration of each part on the basis of the user attribute information registered in the user information DB 172 and the vehicle attribute information registered in the vehicle information DB 174 and registers the derived degree of deterioration in the part information of the vehicle information DB 174. For example, the manager 130 gradually increases the degrees of deterioration of parts as the elapsed time from the date of manufacture or the date of repair included in the vehicle attribute information increases. For example, if the location of a user U is in a salt-damaged area, the manager 130 increases the degrees of deterioration of exterior parts (vehicle body parts) to be greater than those of parts of vehicles of users in non-salt damage areas even if the elapsed times are the same on the basis of user information. The manager 130 may increase the degrees of deterioration as the frequency of sudden acceleration, sudden deceleration, or sharp steering increases, as the frequency of boarding in a predetermined period increases, or as the average travel distance or average travel time per ride increases on the basis of the driving state of the user information. The manager 130 may increase the degree of deterioration as the period of use of a part is closer to the lifespan of the part included in the part information or as the duration exceeding the lifespan of the part is longer. A part that has exceeded the lifespan thereof may be managed by the manager 130 such that it is not reused. The manager 130 may combine a plurality of methods for deriving degrees of deterioration described above to derive a final degree of deterioration for each part.

The manager 130 may derive the degree of deterioration of each part using a trained model that receives at least one piece of information included in the user attribute information and the vehicle attribute information as input and outputs a degree of deterioration. This trained model may be updated using functions of artificial intelligence (AI) such as machine learning (neural network) and deep learning using teacher (correct answer) data, for example. The trained model may be stored in the server-side storage 170 or may be acquired from an external device via the network NW. The manager 130 derives the degree of deterioration of each part at a predetermined cycle or a predetermined timing, and registers it in the vehicle information DB 174.

Here, it is assumed that the user U1 scraps the used vehicle M1 in order to transfer to another vehicle, for example. In this case, the repair plant 300 to which the vehicle M1 has been transported transmits information identifying the user U1 and the vehicle M1 to the management server 100. Upon receiving an inquiry, the acquirer 120 of the management server 100 acquires part information (part IDs and deterioration states) included in vehicle M1 with reference to the vehicle information DB 174 using the transmitted information. Subsequently, the selector 140 selects parts whose degrees of deterioration are less than a threshold value for each part included in the deterioration states as reusable parts.

The threshold value may be a fixed value or a variable value. In the case of a variable value, the selector 140, for example, changes the threshold value on the basis of attribute information (user attribute information) of the user of a vehicle to which parts will be provided. Specifically, the selector 140 sets a threshold value for business use to be higher than a threshold value for personal use on the basis of the usage included in the user attribute information of the user information DB 171. In the case of business use, the company can conduct its own periodical vehicle check in a short period of time, and thus even parts with relatively high degrees of deterioration can be determined to be usable and selected. In a case where the selector 140 selects parts to be diverted to a vehicle of a user who has used the vehicle M less frequently for a predetermined period of time, traveled a short distance, or traveled for a short time, the selector 140 set a threshold value to be higher than that for a user who has used a vehicle more frequently, traveled a longer distance, or traveled for a longer time on the basis of the driving state of the user included in the user attribute information. Since it is assumed that a vehicle with a low frequency of use, a short travel distance, and a short travel time is slowly deteriorating, it can be used for a long period of time even if the degree of deterioration is high to some extent. The selector 140 may change the threshold value for each type of part. As a result, more appropriate reuse can be achieved for each part.

The identifier 150 identifies a vehicle (diversion destination vehicle) to which a part selected by the selector 140 can be diverted. The identifier 150 extracts other vehicles including the selected part with reference to the vehicle information DB 174 on the basis of the part ID of the selected part, and acquires vehicle attribute information, parts, and deterioration states of the extracted other vehicles. Then, the identifier 150 identifies, as a diversion destination vehicle, a vehicle in which a part having a degree of deterioration higher than that of the selected part is mounted among the extracted other vehicles.

The identifier 150 may acquire the degree of deterioration of each part of the vehicle, and if the average value of the acquired degrees of deterioration and the degree of deterioration of the selected part are close (if the difference is less than a threshold value), identify the vehicle as a diversion destination vehicle. This makes it possible to equalize the degree of deterioration of each part in the vehicle. Therefore, in a case where the diversion destination vehicle is scrapped in the future, each part has deteriorated to the same degree, and thus it is possible to scrap the entire vehicle including other parts, without removing some parts, and it is possible to reduce a load of removing work for reuse, and the like and to reduce the energy consumption associated with the removing work.

The identifier 150 may identify the diversion destination vehicle on the basis of user information. In this case, the identifier 150 identifies, as the diversion destination vehicle, a vehicle used by a user whose driving state is similar to that of the user on the basis of the driving state of the user included in the user attribute information. For example, parts used by a user who uses the vehicle M less frequently are diverted to a vehicle that is used less frequently similarly, and thus the degrees of deterioration thereof are likely to be close to those of other parts of the diversion destination vehicle. In a case where the location of the user U included in the user attribute information is in a salt-damaged area, the identifier 150 identifies a vehicle of a user in the same salt-damaged area as the diversion destination vehicle. As a result, it is possible to intentionally provide parts that have been affected by salt damage in the same way as other parts, and thus it is possible to approximate the degree of progress of deterioration over time to the other parts. In this manner, it is possible to provide parts that match the influence that other parts have received in the past, and thus, at the time of scrapping the diversion destination vehicle, it is possible to scrap the entire vehicle including other parts and reduce a work load related to removing work and energy consumption.

The identifier 150 may identify, as the diversion destination vehicle, a vehicle driven by a user who is in a driving state different from the driving state of the user U1 of the vehicle M1 in which the selected part is mounted. For example, in a case where the user U1 who does make sudden accelerations, sudden decelerations, or sharp steering frequently (so-called a severe user), a vehicle used by a user who does not make sudden accelerations, sudden decelerations, or sharp steering frequently (so-called a mild user) is identified as a diversion destination vehicle. As a result, it is possible to curb further deterioration of parts deteriorated by the severe user and thus it is possible to increase the possibility that the parts can be used until the end of lifespans thereof. Therefore, the parts can be effectively used for a longer period of time and the number of new parts to be manufactured and the frequency of manufacturing can be reduced, thereby reducing energy consumptions.

In the example of FIG. 7, the selector 140 selects the part PT102 (window) and the part PT103 (hood) as parts having degrees of deterioration less than a threshold value (for example, degree of deterioration of 4). The identifier 150 identifies a diversion destination vehicle of the parts PT102 and PT103, and identifies the vehicle M2 having a part with a higher degree of deterioration than the selected parts as the diversion destination vehicle. Since the degree of deterioration of the part PT101 (door part) exceeds an upper limit value (for example, degree of deterioration of 7), the identifier 150 identifies the part as a part to be discarded (part that is not to be reused).

In FIG. 7, the repair plant 300 may transmit the identification information of the user U2 and the vehicle M2 to the management server 100 in case of performing maintenance such as vehicle inspection of the vehicle M2, inquire about parts, and if there is a part of the vehicle M2 identified as a diversion destination vehicle, acquire information on the part and perform replacement of the part, and the like. Upon receiving an instruction to replace the part PT102 from the user U2 of the vehicle M2, the repair plant 300 may inquire of the management server 100 about the inventory of the part PT102 for replacement.

The manager 130 of the management server 100 may manage fees for reuse of parts, and the like. For example, the manager 130 reduces the fee for using a part (used part) identified by the identifier 150 as compared to a case of using a new part. As a result, utilization of used parts can be promoted. The manager 130 may notify the user U2 of the diversion destination vehicle (vehicle M2) that there is a used part with a low degree of deterioration or may inquire of the user U2 whether or not to divert.

<Second Processing>

FIG. 8 is a diagram illustrating second processing executed by the management server 100. In the second processing, it is determined whether or not a reuse vehicle (for example, a vehicle in which the ratio of reuse parts to all parts is equal to or greater than a threshold value) can be manufactured only from parts of a plurality of scrapped vehicles. FIG. 8 shows, as an example, common parts (PT101, PT201, PT203, and PT204) mounted in the vehicles M10 and M20, and a degree of deterioration of each part.

In the second processing, the selector 140 selects parts having degrees of deterioration less than the threshold value with reference to the vehicle information DB 174 stored in the server-side storage 170 as in the first processing. In the second processing, the threshold value may be a fixed value, or a variable value changing depending on user attribute information of each of the vehicles M10 and M20 obtained from the user information DB 172 and the purpose of use (for example, personal use or business use) of the reuse vehicle to be manufactured. The identifier 150 determines whether or not a reuse vehicle can be manufactured by combining the plurality of selected parts.

The example of FIG. 8 shows that the selector 140 selects parts having degrees of deterioration less than 3, and the identifier 150 determines that a reuse vehicle M30 can be manufactured using the selected parts. As shown in the second processing, as a diversion destination vehicle, manufacturing a reuse vehicle by combining parts obtained from a plurality of scrapped vehicles as well as a vehicle in use is also managed, and thus it is possible to achieve inventory storage as parts and effectively use parts.

In the second processing, in a case where the manager 130 has received a request from a certain service user indicating that he or she wants a reuse vehicle manufactured using parts with degrees of deterioration less than 4, for example, the manager 130 determines whether or not it is possible to select requested parts from among a plurality of parts and to manufacture a reuse vehicle, as described above, and transmit the determination result to the service user who has sent the request. In the second processing, in a case where a plurality of identical parts are selected, the manager 130 may provide deterioration information for each part and vehicle attribute information of the original vehicle to the service user and perform control to cause the user to select parts to be used. This makes it possible to provide a reuse vehicle desired by the service user. According to the second processing, it is possible to promote the use of reuse vehicles and reduce the energy consumption associated with inventory management (for example, transportation of inventory and maintenance of inventory parts).

<Third Processing>

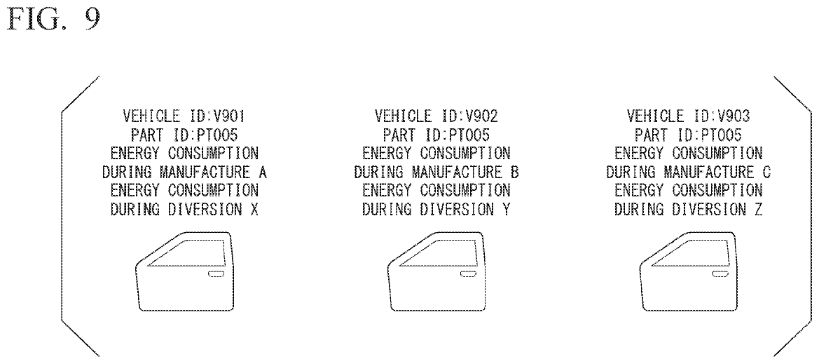

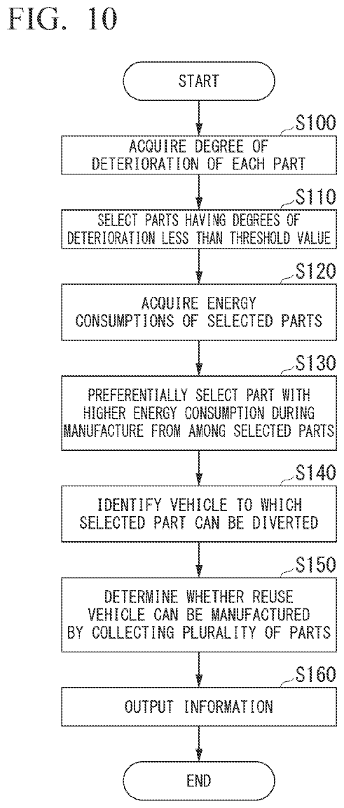

FIG. 9 is a diagram illustrating third processing executed by the management server 100. In the third processing, a part is selected on the basis of the energy consumption of each part. The example of FIG. 9 shows the energy consumption (energy consumption during manufacture, energy consumption during diversion) of the same part PT005 (door part) having the same degree of deterioration (different degrees of deterioration less than a threshold value may be acceptable) obtained from each of three different vehicles (vehicle IDs: V901, V902, and V903). In the third processing, the manager 130 acquires the energy consumption of each part with reference to the energy consumption DB 176. Then, the selector 140 preferentially selects a part with a higher energy consumption during manufacture from among the plurality of parts of the same type. As a result, it is possible to preferentially utilize a part with a higher energy consumption during manufacture and it is possible to prolong the number of productions and the frequency of manufacturing. Therefore, the energy consumption during manufacture can be reduced.

The selector 140 may preferentially select a part with a lower energy consumption during diversion instead of energy consumption during manufacture. As a result, it is possible to preferentially utilize a part with a lower energy consumption during diversion, and thus energy consumption during diversion can be reduced.

The selector 140 may combine both the energy consumption during manufacture and the energy consumption during diversion to make a comprehensive determination and select a part. For example, the selector 140 compares the energy consumption during manufacture and the energy consumption during diversion, and determines whether or not to select a part as a diverted part on the basis of the lower energy consumption obtained as a result of comparison. Specifically, if the energy consumption during diversion is lower than the energy consumption during manufacture, the selector 140 selects the part as a diverted part, and if the energy consumption during diversion is higher than the energy consumption during manufacture, causes a new part to be used (promotes use of a newly manufactured part) instead of selecting the part as a diverted part. The selector 140 calculates the difference value between the consumptions, selects the part as a diverted part if the difference value is equal to or greater than a predetermined value, and causes a new part to be used instead of selecting the part as a diverted part if the difference value is less than the predetermined value. Further, the selector 140 may not select the part as a diverted part in a case where the degree of deterioration of the part is equal to or greater than a threshold value even if the difference value is equal to or greater than the predetermined value. As a result, it is possible to select a more appropriate parts in consideration of balance between the energy consumption and the degree of deterioration.

In the example of FIG. 9, it is assumed that, among energy consumptions A, B, and C during manufacture, A is lowest and B and C are lager in order, and among energy consumptions X, Y, and Z during diversion, X is lowest and Y and Z are larger in order. In this case, the selector 140 selects the part with the vehicle ID “V903” having the energy consumption C during manufacture when the energy consumption during manufacture is used as the standard, and selects the part with the vehicle ID “V901” having the energy consumption X during diversion when the energy consumption during diversion is used as the standard. Which energy consumption will be used at the time of selection may be set by a user or may be set using vehicle attribute information of the diversion destination vehicle and user attribute information of a user who uses the diversion destination vehicle.

In a case where a part is selected and a diversion destination vehicle is identified according to the first processing to the third processing described above, the provider 160 outputs information on the selected part to the repair plant 300 and the user U of the diversion destination vehicle. The manager 130 may perform various types of processing such as transportation of parts, schedule management, and charge settlement.

In a case where replacement of a part or manufacture of a part (or a vehicle or a reuse vehicle) has been executed, the manager 130 updates the user information DB 172, the vehicle information DB 174, and the energy consumption DB 176 stored in the server-side storage 170 on the basis of the execution result.

Each of the first processing to the third processing described above may be combined with part or all of other processing. For example, the management server 100 may select parts with degrees of deterioration less than the threshold value according to the first processing, and if there are a plurality of identical parts among the selected parts, select parts based on energy consumption using the third processing. The management server 100 may identify a vehicle to which the selected parts can be diverted in the first processing, determine whether or not a reuse vehicle can be identified in the second processing, and output the respective results.

### [Processing Flow]

Next, processing executed by the management server 100 of the embodiment will be described. In processing executed by the management server 100, processing related to selection of parts that can be diverted and identification of a diversion destination vehicle will be mainly described below. The following processing may be executed at a predetermined cycle or a predetermined timing (for example, a case where there is an inquiry, and the like). It is assumed that the manager 130 stores the user information DB 172, the vehicle information DB 174, and the energy consumption DB 176 and manages the deterioration state of each part before execution of the following processing.

FIG. 10 is a flowchart showing an example of processing executed by the management server 100 of the embodiment. FIG. 10 shows an example of processing in which the first processing to the third processing described above are combined. In the example of FIG. 10, the acquirer 120 acquires the degree of deterioration of each part with reference to the vehicle information DB 174 (step S100). Subsequently, the selector 140 selects parts with degrees of deterioration less than a threshold value from the acquired information (step S110). Subsequently, the acquirer 120 acquires energy consumptions of the selected parts with reference to the energy consumption DB 176 on the basis of part IDs and vehicle IDs selected by the selector 140 (step S120). Subsequently, the selector 140 preferentially selects a part having a higher energy consumption during manufacture from among the selected parts (step S130). In processing of step S130, the selector 140 may select a preferential part on the basis of the energy consumption during diversion instead of (or in addition to) the energy consumption during manufacture.

Subsequently, the identifier 150 identifies a vehicle to which the selected part can be diverted (step S150). Subsequently, the identifier 150 determines whether a reuse vehicle can be manufactured by collecting a plurality of parts (step S160). Subsequently, the provider 160 outputs information indicating the processing results of steps S140 and S150 (step S160). Accordingly, processing of this flowchart ends.

According to the embodiment described above, it is possible to reuse parts of a vehicle more efficiently to reduce carbon dioxide emissions by including, in the management server (management apparatus) 100, the acquirer 120 that acquires a degree of deterioration of each part included in a vehicle M, a selector 140 that selects parts having degrees of deterioration acquired by the acquirer 120, less than a threshold value, from among parts included in the vehicle M, and an identifier 150 that identifies a diversion destination vehicle to which the parts selected by the selector 140 will be diverted. Therefore, it is possible to contribute to mitigation of climate change or reduction of influence of climate change.

Specifically, according to the embodiment, it is possible to use parts for a long period of time in a more appropriate condition on the basis of the degree of deterioration of each part of a vehicle rather than each vehicle, and manage environmental load (energy consumption) more appropriately. Therefore, total energy consumption can be reduced. According to the embodiment, it is possible to equalize degrees of deterioration of parts in a vehicle by selecting parts having degrees of deterioration substantially equal to those of other parts of a diversion destination vehicle instead of selecting parts having lower degrees of deterioration. Therefore, in a case where the diversion destination vehicle is scrapped in the future, each part has deteriorated to the same degree, and thus it is possible to scrap the entire vehicle including other parts, without removing some parts, and it is possible to reduce a load of removing work for reuse, and the like and to reduce the energy consumption associated with the removing work.

The embodiment described above can be represented as follows.

A management apparatus including:
a storage medium that stores computer-readable instructions; and
a processor connected to the storage medium,
the processor executing the computer-readable instructions to:
acquire a degree of deterioration of each part included in a vehicle;
select a part having the acquired degree of deterioration less than a threshold value from among parts included in the vehicle; and
identify a diversion destination vehicle to which the selected part will be diverted.

Although the mode for carrying out the present invention has been described above using embodiments, the present invention is not limited to such embodiments, and various modifications and substitutions can be made without departing from the scope of the present invention.

What is claimed is:

1. A management apparatus comprising:
an acquirer configured to acquire a degree of deterioration of each part included in a vehicle;
a selector configured to select a part having a degree of deterioration acquired by the acquirer, which is less than a threshold value, from among parts included in the vehicle; and
an identifier configured to identify a diversion destination vehicle to which the selected part will be diverted.

2. The management apparatus according to claim 1, wherein the selector changes the threshold value on the basis of attribute information of a user who uses the diversion destination vehicle.

3. The management apparatus according to claim 1, wherein the identifier identifies the diversion destination vehicle on the basis of the attribute information of the user who uses the diversion destination vehicle or attribute information of the diversion destination vehicle.

4. The management apparatus according to claim 1, wherein the identifier determines whether a reuse vehicle is able to be manufactured using the part selected by the selector.

5. The management apparatus according to claim 1, wherein the acquirer further acquires an energy consumption during manufacture at the time of newly manufacturing the part, and in a case where there are a plurality of parts of the same type, the selector preferentially selects a part with a higher energy consumption during manufacture from among the parts.

6. The management apparatus according to claim 1, wherein the acquirer further acquires an energy consumption during diversion at the time of diverting the parts to another vehicle, and in a case where there are a plurality of parts of the same type, the selector preferentially selects a part with a lower energy consumption during diversion from among the parts.

7. The management apparatus according to claim 1, wherein the acquirer acquires an energy consumption during manufacture at the time of newly manufacturing the part and an energy consumption during diversion at the time of diverting the part to another vehicle, and the selector selects the part on the basis of the degree of deterioration and a result of comparison between the energy consumption during manufacture and the energy consumption during diversion.

8. The management apparatus according to claim 7, wherein the energy consumption during diversion includes an energy consumption at the time of collecting parts from the vehicle.

9. A management method, using a computer, comprising:
acquiring a degree of deterioration of each part included in a vehicle;
selecting a part having a degree of deterioration acquired by the acquirer, less than a threshold value, from among parts included in the vehicle; and
identifying a diversion destination vehicle to which the selected part will be diverted.

10. A computer-readable non-transitory storage medium storing a program causing a computer to:
acquire a degree of deterioration of each part included in a vehicle;
select a part having a degree of deterioration acquired by the acquirer, less than a threshold value, from among parts included in the vehicle; and
identify a diversion destination vehicle to which the selected part will be diverted.
